(19) United States
(12) Patent Application Publication
(10) Pub. No.: US 2008/0050497 A1
(43) Pub. Date: Feb. 28, 2008

(54) Food Composition Containing a Coagulated Protein and a Process for Making the Same

(75) Inventors: Jimbin Mai, St. Louis, MO (US); Luzviminda C. Lopez, Florissant, MO (US)

Correspondence Address: SOLAE, LLC, P. O. BOX 88940, ST. LOUIS, MO, 63188, US

(73) Assignee: Solae, LLC, St. Louis, MO (US)

(21) Appl. No.: 11/832,967

(22) Filed: Aug. 2, 2007

Related U.S. Application Data
(60) Provisional application No. 60/821,244, filed on Aug. 2, 2006.

(51) Int. Cl. A23L 1/0532; A23L 1/05; A23L 1/0524; A23L 1/0534; A23L 2/02; A23L 1/22; A23L 1/0526; A23L 1/053

(52) U.S. Cl. 426/575; 426/573; 426/577; 426/599; 426/650

(57) ABSTRACT

This invention is directed to a food composition containing a coagulated protein, comprising; (A) a hydrated protein stabilizing agent; (B) a dispersed coagulated protein material; and (C) a flavoring material. Also disclosed is a process for preparing a food composition containing a coagulated protein comprising; combining (A) a hydrated protein stabilizing agent; (B) a dispersed coagulated protein material; and (C) a flavoring material; to form a blend and pasteurizing and homogenizing the blend.

### FIELD OF THE INVENTION

This invention relates to a food composition containing a coagulated protein and a process for making the composition. A coagulated protein is employed as the protein source in place of the typical non-coagulated protein. The composition can be used in foods, including neutral beverages, acid beverages, frozen and refrigerated dessert, and processed meat products to obtain a smooth, creamy consistent texture with superior stability in high protein applications. When used in an acid beverage application, the acid beverage is smooth, tasteful, palatable and has good storage stability and shake-back properties.

### BACKGROUND OF THE INVENTION

Juices and other acidic juice-like beverages are popular commercial products. Consumer demand for nutritional healthy beverages has led to the development of nutritional juice or juice-like beverages containing protein. The protein provides nutrition in addition to the nutrients provided by the components of the beverage. Recently it has been discovered that certain proteins have specific health benefits beyond providing nutrition. For example, soy protein has been recognized by the United States Food and Drug Administration as being effective to lower blood cholesterol concentrations in conjunction with a healthy diet. In response, there has been a growing consumer demand for acidic juice-like beverages containing proteins that provide such specific health benefits.

The relative insolubility of proteins in an aqueous acidic environment has been a hurdle to adding protein to acidic beverages. Most commonly used proteins, such as soy proteins and casein, have an isoelectric point at an acidic pH. Thus, the proteins are least soluble in an aqueous liquid at or near the pH of acidic beverages. For example, soy protein has an isoelectric point at pH 4.5 and casein has an isoelectric point at a pH of 4.7, while most common juices have a pH in the range of 3.7 to 4.0. As a result, protein tends to settle out as sediment in an acidic protein-containing beverage. This sedimentation is an undesirable quality in a beverage.

Further, consumer demand has increased for food products that are high in protein. Especially high in proteins having specific health benefits, such as soy protein.

Protein stabilizing agents that stabilize proteins as a suspension in an aqueous acidic environment are used to overcome the problems presented by protein insolubility. Pectin is a commonly used protein stabilizing agent. Pectin, however, is an expensive food ingredient, and manufacturers of aqueous acidic beverages containing protein desire less expensive stabilizers, where the amount of required pectin is either reduced or removed in favor of less expensive stabilizing agents.

A protein based acid beverage is normally stabilized by a stabilizing agent that provides a stable suspension through possible steric stabilization and an electrostatic repulsive mechanism. FIG. 1 refers to the normal processing conditions of protein stabilized acid beverages. At 1, a stabilizing agent is either hydrated separately into a 2%-3% slurry or blended with sugar to yield a stabilizing agent slurry having a pH of 3.5. At 5, dry protein powder is first dispersed in water at ambient temperature and hydrated at an elevated temperature for a period of time. The pH at 5 is about neutral. The hydrated stabilizing agent slurry from 1 and the hydrated protein slurry from 5 are mixed together at 10 for 10 minutes under agitation. The pH at 10 is about 7. Other ingredients such as additional sugar, fruit juices, vegetable juice, and various acids such as phosphoric acid, ascorbic acid, citric acid, etc., are added at 20 to bring the pH to about 3.8. The contents are pasteurized at 91° C. (195° F.) for 30 seconds and then homogenized first at 2500 pounds per square inch and then at 500 pounds per square inch at 30. Containers are hot filled and cooled at 40 to yield the product at 50 with a pH of 3.8. The problem with this method is that after the stabilizing agent is mixed with the protein, the pH of the blend is close to neutral, and the stabilizing agent is potentially degraded by beta-elimination, especially under heat. This causes both a decrease in the molecular weight of the stabilizing agent and a reduction in the ability of the stabilizing agent to stabilize the proteins when the pH is later lowered even more. The stabilizing agent is only stable at room temperature. As the temperature increases, beta-elimination begins, which results in chain cleavage and a rapid loss of the ability of the stabilizing agent to provide a stable suspension.

Soy milk is an alternative raw material that could be used in juice drinks. However, the low protein content of soy milk coupled with its beany flavor, limit the application of soy milk in juice drinks.

An advantage of the present invention is that food products can be made to contain high amounts of protein compared to that food products' traditional counterpart. The high protein food products retain the creamy, consistent texture of the traditional counterpart while including higher amounts of protein than typically found in the food product. The coagulated protein can be used in both neutral beverage and acid beverage applications.

In meat, meat substitutes, meat replacements, and processed meat applications, the present invention can be used to improve texture and consistency of the product.

Another advantage of the present invention is that while a soy protein is employed for acid beverages, the soy protein has been subjected to a coagulation step by the use of a coagulant to form a coagulated protein.

A further advantage of the present invention in acid beverage compositions is that the level of pectin can be reduced without negatively impacting overall acceptability as measured using the 9 point hedonic scale. Thus, comparable sensory acceptability, as measured by the 9 point hedonic scale can be achieved in the application of the present invention, while using less pectin.

### SUMMARY OF THE INVENTION

The present invention is directed to a food composition containing a coagulated protein, comprising;

(A) a hydrated protein stabilizing agent;

(B) a dispersed coagulated protein material; and

(C) a flavoring material selected from the group consisting of a fruit juice, a vegetable juice, citric acid, malic acid, tartaric acid, lactic acid, acetic acid, ascorbic acid, and mixtures thereof. The food composition can contain other ingredients typically found in the particular food composition being produced.

Also disclosed is a process for preparing a food composition comprising; combining

(A) a hydrated protein stabilizing agent;

(B) a dispersed coagulated protein material prepared by
(1) hydrating a protein material to form a first aqueous slurry mixture,
(2) adding at least one supporting material to the first aqueous slurry mixture to form a second aqueous slurry mixture,
(3) homogenizing the second aqueous slurry mixture to a homogenate, and
(4) adding a coagulant having a pH of from about 3.8 to about 7.2 to the homogenate to form a dispersed coagulated protein; and
(C) a flavoring material selected from the group consisting of a fruit juice, a vegetable juice, citric acid, malic acid, tartaric acid, lactic acid, acetic acid, ascorbic acid, and mixtures thereof;
to form a blend and
pasteurizing and homogenizing the blend. Other ingredients known in the art can be added as needed to make specific food compositions.

In another embodiment, the present invention is directed to an acid beverage composition, comprising;

(A) a hydrated protein stabilizing agent;

(B) a dispersed coagulated protein material; and

(C) a flavoring material selected from the group consisting of a fruit juice, a vegetable juice, citric acid, malic acid, tartaric acid, lactic acid, acetic acid, ascorbic acid, and mixtures thereof;

wherein the acid beverage composition has a pH of from 3.0 to 4.5.

Also disclosed is a process for preparing an acid beverage composition comprising;

combining

(A) a hydrated protein stabilizing agent;

(B) a dispersed coagulated protein material prepared by
(1) hydrating a protein material to form a first aqueous slurry mixture,
(2) adding at least one supporting material to the first aqueous slurry mixture to form a second aqueous slurry mixture,
(3) homogenizing the second aqueous slurry mixture to a homogenate, and
(4) adding a coagulant having a pH of from about 3.8 to about 7.2 to the homogenate to form a dispersed coagulated protein; and

(C) a flavoring material selected from the group consisting of a fruit juice, a vegetable juice, citric acid, malic acid, tartaric acid, lactic acid, acetic acid, ascorbic acid, and mixtures thereof;
to form a blend and
pasteurizing and homogenizing the blend;
wherein the acid beverage has a pH of from about 3.0 to about 4.5.

### BRIEF DESCRIPTION OF THE DRAWINGS

FIG. 1 is a block flow diagram of a current industry wide process for producing a typical protein containing acid beverage wherein a dry protein is hydrated as a protein slurry and a dry stabilizing agent is hydrated as a stabilizing agent slurry, the two slurries are blended together and the remaining ingredients are added followed by pasteurization and homogenization.

FIG. 2 is a block flow diagram of the process of the present invention for producing a dispersed coagulated protein. Dry protein is hydrated as an aqueous slurry. A supporting material is added and the slurry is homogenized and coagulated according to the principles of the invention.

FIG. 2A is a block flow diagram of the process of the present invention for producing a protein containing acid beverage. A stabilizing agent is hydrated and combined with the dispersed coagulated protein and a flavoring material, followed by pasteurization and homogenization in accordance with the principles of the present invention.

### DETAILED DESCRIPTION OF THE INVENTION

In the present invention, the idea of applying tofu manufacturing technology to coagulate the protein in either soymilk or reconstituted soy milk from full fat or defatted soy flour, soy concentrates, soy protein isolates, and mixtures thereof is described. Once formed, the coagulate is then formulated into a protein containing food composition. The food composition can be a neutral beverage or an acid beverage. When the food composition is a beverage, it can include juices, juice concentrates, acidulants, sweeteners, stabilizers, other nutrients, and mixtures thereof. The beverage is then homogenized and pasteurized to produce a beverage having a smooth mouth feel and an excellent suspension throughout the shelf life of the beverage. When the food composition is an acid beverage, the acid beverage has a pH of between about 3.0 and about 4.5.

The food composition can also be selected from the group consisting of baked products, pies, pie fillings, yogurt, ice cream fruit preparations, confectionary fillings, fruit preparations, fruit leathers, processed cheese preparations including cream cheese, fruit juice concentrates for beverage processing lines, juice dispensers, ice cream mixes including regular and soft serve, yogurt bases, smoothies, dairy products, fruit gels, sauces, gravies, savory food products, frozen food products, sausages, emulsified meats, and hotdogs. The food composition can further be an animal food product selected from the group consisting of shelf stable, moist animal food products, emulsified meat preparations, and injected products.

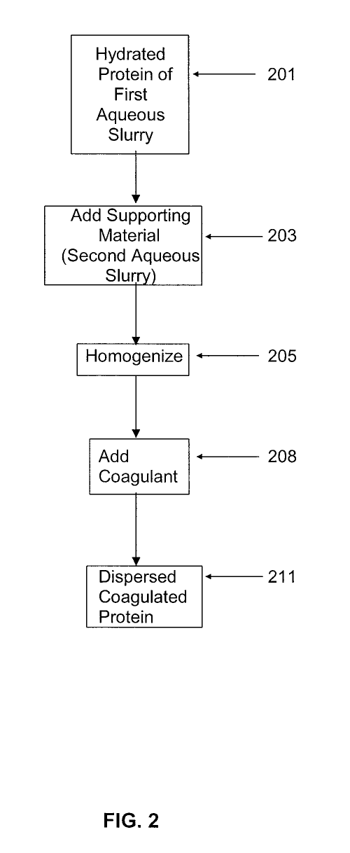

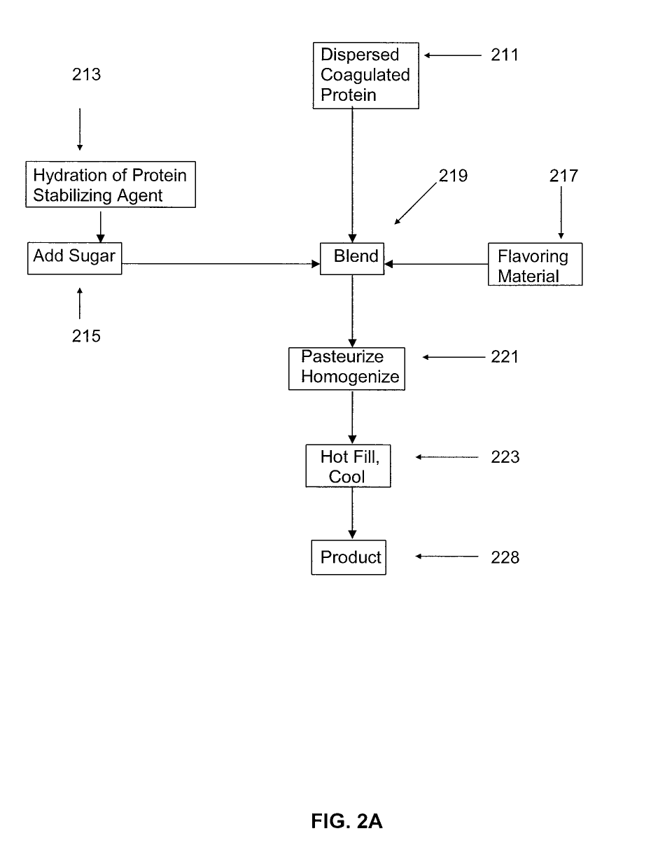

FIG. 2 relates to the preparation of a dispersed protein coagulate for use in the preparation of an acid beverage, as described in FIG. 2A. In FIG. 2, a first protein slurry is hydrated at 201 from a dry protein material. At 203 a supporting material is added to the hydrated protein slurry to form a second slurry. The second slurry is homogenized at 205 to form a homogenate. At 208 a coagulant is added to the homogenate to form a dispersed coagulated protein at 211.

In FIG. 2A, a stabilizing agent, is hydrated at 213. Sugar is added at 215. A flavoring material is prepared at 217. The dispersed coagulated protein of 211, the hydrated and sweetened stabilizing agent of 215, and the flavoring material of 217 are combined at 219 to form a blend. The blend is pasteurized and homogenized at 221. In a preferred embodiment, the blend is pasteurized at a temperature of at least about 82° C. (180° F.) for at least about 10 seconds. The weight ratio of the hydrated protein stabilizing agent: the dispersed coagulated protein: the flavoring material is about 5-15:15-25:60-75. Containers are hot filled with the blend and cooled at 223 to yield a product with a pH of 3.8 at 228.

The Stabilizing Agent

The present invention employs a stabilizing agent present at from about 0.5% to about 5% by weight of the total composition. The stabilizing agent is a hydrocolloid selected from the group consisting of alginate, microcrystalline cellulose, jellan gum, tara gum, carrageenan, guar gum, locust bean gum, xanthan gum, cellulose gum, pectin, and mixtures thereof. A preferred hydrocolloid is high methoxyl pectin. As used herein, the term “pectin” means a neutral hydrocolloid that consists mainly of partly methoxylated polygalacturonic acid. The term “high methoxyl pectin” as used herein means a pectin having a degree of methoxyl esterification of fifty percent (50%) or greater. High methoxyl (HM) pectins useful in the present invention are commercially available. One supplier is Copenhagen Pectin A/S, a division of Hercules Incorporated, DK-4623, Lille Skensved, Denmark. Their products are identified as Hercules YM100L, Hercules YM100H, Hercules YM115L, Hercules YM115H and Hercules YM150H. Hercules YM100L contains about 56% galacturonic acid, where about 72% (±2%) of the galacturonic acid is methylated. Another product is AMD783 supplied by Danisco A/S of Copenhagen, Denmark.

It is necessary to hydrate the stabilizing agent prior to preparing the beverage. For use in food compositions other than beverages, the stabilizing agent may be hydrated. Water is added to the stabilizing agent in sufficient quantity to form a slurry. The slurry is mixed at room temperature under high shear and heated to 60° C.-82° C. (140° F.-180° F.) for an additional 10 minutes. This solids concentration yields the most complete hydration in the stabilizing agent. Thus, the water in the slurry is used most efficiently at this concentration. For acid beverages, the pH of the protein stabilizing agent is between about 2.0 to about 5.5, preferably between about 3.2 to about 4.0, and more preferably between about 3.6 to about 3.8. A sweetener may be added at this point or later, or a portion of the sweetener added here and also added later. Sweeteners include sugars and artificial sweeteners. Sugars include monosaccharides such as glucose and fructose; disaccharides such as sucrose and maltose; and polysaccharides such as maltodextrin and fructane. Artificial sweeteners include cyclamates, aspartame, saccharine, and sucralose. Preferred sweeteners include sucrose, corn syrup, dextrose, high fructose corn syrup, artificial sweeteners, and mixtures thereof. If desired, a nutraceutical may also be added at this point or later, or a portion of the nutraceutical can be added here and also added later. A nutraceutical is a foodstuff (as a fortified food or dietary supplement) that provides health benefits in addition to its basic nutritional value. Nutraceuticals can include antioxidants such as beta-carotene, lycopene, lutein, and anthocyanin; dietary supplements such as folic acid; and vitamins. Fiber may also be added. Fiber includes inulin, plant fiber, and soy fiber.

Supporting Material

The composition and process of the present invention relate to hydrating a soy protein at a pH of from about 7 to about 8, adding at least one supporting material, followed by homogenization, and further followed by the addition of a coagulant, to produce a dispersed coagulated soy protein.

The purpose of the supporting material is to function as a bulking agent, a surfactant, an emulsifier, or any combination of such. The supporting material in the present invention includes a wide variety of known food ingredients. Examples of such ingredients are mono-, di- and triglycerides, especially a vegetable oil triglyceride; monosaccharides, such as glucose, which is also referred to as dextrose or grape sugar; fructose; disaccharides, such as saccharose, which is not only referred to as sucrose but also as cane or beet sugar; lactose and maltose; oligosaccharides such as stachyose or raffinose; polysaccharides, such as starch, maltodextrins, cyclodextrins, fructanes, including for example inulin (polyfructose) and polydextrose; sugar alcohols, such as sorbitol, mannitol, maltitol, lactitol, xylitol and isomalt; and also other carbohydrates, polyols, and mixtures thereof. Several of the aforementioned products are also available in a hydrated form, for example dextrose monohydrate. Food acids such as lactic acid, apple acid, and citric acid and the like may also be included as the supporting material.

Carbohydrates mean polyhydroxy aldehydes, polyhydroxy ketones or compounds that can be hydrolyzed to polyhydroxy aldehydes and polyhydroxy ketones. A carbohydrate that cannot be hydrolyzed to simpler compounds is called a monosaccharide. A carbohydrate that can be hydrolyzed to two monosaccharide molecules is called a disaccharide. A carbohydrate that can be hydrolyzed to many monosaccharide molecules is called a polysaccharide.

Homogenization serves to decrease the particle size of the protein in the dispersed coagulated protein material. Preferably the second slurry protein material is transferred to a Gaulin homogenizer (model 15MR) and is homogenized in two stages, a high pressure stage and a low pressure stage. The high pressure stage is from 1500-5000 pounds per square inch and preferably from 2000-3000 pounds per square inch. The low pressure stage is from 300-1000 pounds per square inch and preferably from 400-700 pounds per square inch.

A coagulant used in the present invention is a-glucono delta lactone, which may be the only coagulant or may be combined with at least one salt selected from the group consisting of magnesium salts, calcium salts, zinc salts, and mixtures thereof. Magnesium salt can include a natural (salt pan) bittern, magnesium chloride, magnesium sulfate, and mixtures thereof. Calcium salt can include calcium sulfate, calcium chloride, calcium lactate, whey calcium, and mixtures thereof. Zinc salt can include zinc sulfate, zinc chloride, and mixtures thereof. The above-mentioned coagulants can be effectively used to reduce any objectionable odor, bitter taste, and astringent taste of soy protein. It is thought the bittern and the magnesium salt are more effective in providing a soy protein with good body such as a milk taste than the calcium salt. It is preferred to use a-glucono delta lactone in combination with the magnesium salt or the calcium salt. The coagulant has a pH of between about 3.8 to about 7.2. The amount of the coagulant to protein material, on a dry basis, in the homogenized second slurry generally is from about 1:50 to about 1:85, preferably from about 1:60 to about 1:80, and most preferably from about 1:65 to about 1:75.

Coagulated Protein Material

The protein material of the process of the present invention may be any vegetable or animal protein that is at least partially insoluble in an aqueous acidic liquid, preferably in an aqueous acidic liquid having a pH of from about 3.0 to about 5.5, and most preferably in an aqueous acidic liquid having a pH of from about 3.5 to about 4.5. As used herein a “partially insoluble” protein material is a protein material that contains at least 10% insoluble material, by weight of the protein material, at a specified pH. Preferred protein materials useful in the composition of the present invention include vegetable protein materials such as legume protein materials, soy protein materials, pea protein materials, rapeseed protein materials, canola protein materials cottonseed protein materials, corn protein materials—particularly zein, wheat gluten, vegetable whey proteins (i.e., non-dairy whey protein); milk protein materials such as casein, caseinates, dairy whey protein (especially sweet dairy whey protein); non-dairy-whey proteins such as bovine serum albumin, egg protein materials, egg white albumin; and mixtures thereof. Protein materials also include fish and/or meat proteins with free carboxyl groups.

The term “soy protein” is defined as a material from whole soybeans which contains no non-soy derived additives. Such additives may, of course, be added to a soy protein to provide further functionality or nutrient content in an extruded meat analog containing the soy material. The term “soybean” refers to the species Glycine max, Glycine soja, or any species that is sexually cross compatible with Glycine max. It is further contemplated that the whole soybeans used in the process of the present invention may be standard, commoditized soybeans, soybeans that have been genetically modified (GM) in some manner, or non-GM identity preserved soybeans.

Soy protein materials which are useful within the present invention are selected from the group consisting of soy protein flour, soy protein concentrate, soy protein isolate, and mixtures thereof.

Traditional processes for making the soy protein materials including soy protein flours, soy protein concentrates, and soy protein isolates, begin with the same initial steps. Soybeans entering a processing plant must be sound, mature, yellow soybeans. The soybeans can be washed to remove dirt and small stones. They are typically screened to remove damaged beans and foreign materials and may be sorted to uniform size.

Each cleaned, raw soybean is then cracked into several pieces, typically six (6) to eight (8), to produce soy chips and hulls. The hulls are removed by aspiration. Alternatively, the hulls may be loosened by adjusting the moisture level and mildly heating the soybeans before cracking. Hulls can also be removed by passing cracked pieces through corrugated rolls revolving at different speeds. In these methods, the hulls are then removed by a combination of shaker screen and aspiration.

The soy chips, which contain about 11% moisture, are then conditioned at about 60° C. and flaked to about 0.25 millimeter thickness. The resulting flakes are then extracted with an inert solvent, such as a hydrocarbon solvent, typically hexane, in one of several types of countercurrent extraction systems to remove the soybean oil. Hexane extraction is basically an anhydrous process, as with a moisture content of only about 11%, there is very little water present in the soybeans to react with the protein. For soy protein flours, soy protein concentrates, and soy protein isolates, it is important that the flakes be desolventized in a manner which minimizes the amount of cooking or toasting of the soy protein to preserve a high content of water-soluble soy protein. This is typically accomplished by using vapor desolventizers or flash desolventizers. The flakes resulting from this process are generally referred to as “edible defafted flakes.” Specially designed extractors with self-cleaning, no-flake-breakage features, and the use of a narrow boiling range hexane are recommended for producing edible defatted flakes.

The resulting edible defatted flakes, which are the starting material for soy protein flour, soy protein concentrate, and soy protein isolate, have a protein content of approximately 50%. Moisture content has typically been reduced by 3% to 5% during this process. Any residual solvent may be removed by heat and vacuum.

The soy protein flour, soy protein concentrate, and soy protein isolate are described below as containing a protein range based upon a “moisture free basis” (mfb).

The edible defatted flakes are then milled, usually in an open-loop grinding system, by a hammer mill, classifier mill, roller mill, or impact pin mill first into grits, and with additional grinding, into soy flours with desired particle sizes. Screening is typically used to size the product to uniform particle size ranges and can be accomplished with shaker screens or cylindrical centrifugal screeners.

Soy protein flour, as that term is used herein, refers to a comminuted form of defatted soybean material, preferably containing less than 1% oil and formed of particles having a size such that the particles can pass through a No. 100 mesh (U.S. Standard) screen. Soy protein flour has a soy protein content of about 50% to about 65% on a moisture free basis (mfb). Preferably the flour is very finely ground, most preferably so that less than about 1% of the flour is retained on a 300 mesh (U.S. Standard) screen. The remaining components are soy fiber material, fats, minerals, and sugars such as sucrose, raffinose, and stachyose.

Soy protein concentrate, as the term is used herein, refers to a soy protein material containing from about 65% to less than about 90% of soy protein (mfb). The remaining components are soy fiber material, fats, minerals, and sugars such as sucrose, raffinose, and stachyose. Soy protein concentrates are prepared from dehulled and defatted soy flakes by removing most of the water-soluble, non-protein constituents. The “traditional method” for preparing soy protein concentrates is by aqueous alcohol leaching. In this method, edible defatted soy flakes are leached (washed) with alcohol and water. The alcohol and water is typically 60% to 90% ethanol, and removes much of the soluble sugars. The soluble sugars are separated from the wet flakes with the soluble sugars being used for some other purpose or discarded. The wet flakes are transferred to a desolventizer. Sufficient heat is used in the desolventizer to increase the vapor pressure of the alcohol and water to remove that liquid, but is sufficiently low enough to minimize cooking of the protein. The application of reduced pressures over the liquid bearing mass also increases the rate of removal of the liquid.

The remaining water and wet flakes are dried in a dryer to remove water and to produce a soy protein concentrate.

Secondary treatments such as high pressure homogenization or jet cooking are used to restore some solubility lost during processing.

Another less used method for producing soy protein concentrates is by acid leaching. Edible defatted flakes and water are combined in a ratio of about 10:1 to about 20:1 water to edible defatted flakes, with a food-grade acid (water plus acid) typically hydrochloric acid, to adjust the pH to about 4.5. The extraction typically runs for about 30 minutes to about 45 minutes at about 40° C. The acid-leached flakes are separated from the acid solubles to concentrate the solids to about 20%. A second leach and centrifugation may also be employed. The acid solubles are used for some other purpose or are discarded. The acidified wet flakes are neutralized to a pH of about 7.0 with alkali and water (e.g., sodium hydroxide or calcium hydroxide) to produce neutralized water and wet flakes. The neutralized water is separated from the wet flakes and the wet flakes are spray dried at about 157° C. inlet air temperature and about 86° C. outlet temperature to remove water and to produce soy protein concentrate. Soy protein concentrates are commercially available from Solae® LLC, (St. Louis, Mo.) for example, as Alpha™ DSPC, Procon™, Alpha™ 12 and Alpha™ 5800.

Soy protein isolate, as the term is used herein, refers to a soy protein material containing at least about 90% protein content (mfb). The remaining components are soy fiber material, fats, minerals, and sugars such as sucrose, raffinose, and stachyose. The edible defafted flakes are placed in an aqueous bath to provide a mixture having a pH of at least about 6.5 and preferably between about 7.0 and about 10.0 in order to extract the protein. Typically, if it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the soy protein. Typically, the pH of the aqueous extract of soy protein will be at least about 6.5 and preferably about 7.0 to about 10.0. The ratio by weight of the aqueous extractant to the edible defatted flakes is usually between about 20:1 and preferably a ratio of about 10:1. Before continuing a work-up of the extract, the extract is centrifuged to remove insoluble carbohydrates. A second extraction is performed on the insoluble carbohydrates to remove any additional soy protein. The second extract is centrifuged to yield any further insoluble carbohydrates and a second aqueous extract. The first and second extracts are combined for the work-up. The insoluble carbohydrates are used to obtain the soy fiber. In an alternative embodiment, the soy protein is extracted from the edible defatted flakes with water, that is, without a pH adjustment.

It is also desirable in obtaining the soy protein isolate used in the present invention, that an elevated temperature be employed during the aqueous extraction step, either with or without a pH adjustment, to facilitate solubilization of the protein, although ambient temperatures are equally satisfactory if desired. The extraction temperatures which may be employed can range from ambient up to about 49° C. (120° F.) with a preferred temperature of about 32° C. (90° F.). The period of extraction is further non-limiting and a period of time between about 5 minutes to about 120 minutes may be conveniently employed with a preferred time of about 30 minutes. Following extraction of the soy protein material, the aqueous extract of soy protein can be stored in a holding tank or suitable container while a second extraction is performed on the insoluble solids from the first aqueous extraction step. This improves the efficiency and yield of the extraction process by exhaustively extracting the soy protein from the residual solids of the first step.

The combined aqueous soy protein extracts from both extraction steps, without the pH adjustment or having a pH of at least about 6.5, or preferably about 7.0 to about 10, are then precipitated by adjustment of the pH of the extracts to at or near the isoelectric point of the soy protein to form an insoluble curd precipitate. The pH to which the soy protein extracts are adjusted is typically between about 4.0 and about 5.0. The precipitation step may be conveniently carried out by the addition of a common food grade acidic reagent such as acetic acid, sulfuric acid, phosphoric acid, hydrochloric acid, or any other suitable acidic reagent. The soy protein precipitates from the acidified extract and is then separated from the extract. The separated soy protein may be washed with water to remove residual soluble carbohydrates and ash from the protein material and the residual acid can be neutralized to a pH of from about 4.0 to about 6.0 by the addition of a basic reagent such as sodium hydroxide or potassium hydroxide. At this point the soy protein material is subjected to a pasteurization step. The pasteurization step kills microorganisms that may be present. Pasteurization is carried out at a temperature of at least about 82° C. (180° F.) for at least about 10 seconds, at a temperature of at least about 88° C. (190° F.) for at least about 30 seconds, or at a temperature of at least about 91° C. (195° F.) for at least about 60 seconds. The soy protein material is then dried using conventional drying means to form a soy protein isolate. Soy protein isolates are commercially available from Solae® LLC, for example, as SUPRO® 500E, SUPRO® PLUS 651, SUPRO® PLUS 675, SUPRO® 516, SUPRO® XT 40, SUPRO® 710, SUPRO® 720, FXP 950, FXP HO120, and PROPLUS 500F.

The soy protein material used in the present invention may be modified to enhance the characteristics of the soy protein material. The modifications are modifications which are known in the art to improve the utility or characteristics of a protein material and include, but are not limited to, denaturation and hydrolysis of the protein material.

The soy protein material may be denatured and hydrolyzed to lower the viscosity. Chemical denaturation and hydrolysis of protein materials is well known in the art and typically consists of treating an aqueous soy protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing a soy protein material are: a pH of up to about 10, preferably up to about 9.7; a temperature of about 50° C. to about 80° C. and a time period of about 15 minutes to about 3 hours, where the denaturation and hydrolysis of the aqueous protein material occurs more rapidly at higher pH and temperature conditions.

Hydrolysis of the soy protein material may be accomplished by treating the soy protein material with an enzyme capable of hydrolyzing the soy protein. Many enzymes are known in the art which hydrolyze protein materials including, but not limited to, fungal proteases, pectinases, lactases, and chymotrypsin. Enzyme hydrolysis is effected by adding a sufficient amount of enzyme to an aqueous dispersion of the soy protein material, typically from about 0.1% to about 10% enzyme by weight of the soy protein material, and treating the enzyme and soy protein material at a temperature, typically from about 5° C. to about 75° C., and a pH, typically from about 3 to about 9, at which the enzyme is active for a period of time sufficient to hydrolyze the soy protein material. After sufficient hydrolysis has occurred the enzyme is deactivated by heating to a temperature above about 75° C., and the soy protein material is precipitated by adjusting the pH of the solution to about the isoelectric point of the soy protein material. Enzymes having utility for hydrolysis in the present invention include, but are not limited to, bromelain and alcalase.

In starting with a dry protein material such as a soy protein isolate, the isolate powder is hydrated to form a first aqueous slurry mixture as the first step in protein coagulation. It is critical to hydrate the protein material to an aqueous dispersion. In hydration, the protein solids absorb water, causing the protein solids to become softer and larger. At this point, the supporting material is added to the first aqueous slurry mixture to form a second aqueous slurry mixture. The second aqueous slurry mixture is then homogenized to a homogenate. When the softer and larger protein particles are subjected to homogenization, the particle size of the protein is reduced more readily due to the protein particles being softer and larger. A coagulant is then added to the homogenate to form a dispersed coagulated protein.

The starting material can be a liquid protein material. When a liquid protein material is used, the additional ingredients are added directly to the liquid protein material. Thus, the need to spray dry the protein material is avoided. The homogenized liquid mix is commercially sterilized, further homogenized, and packaged. Keeping the protein in liquid form ensures that the protein functionalities are retained.

Casein protein materials useful in the process of the present invention are prepared by coagulation of a curd from skim milk. The casein is coagulated by acid coagulation, natural souring, or rennet coagulation. To effect acid coagulation of casein, a suitable acid, preferably hydrochloric acid, is added to milk to lower the pH of the milk to around the isoelectric point of the casein, preferably to a pH of from about 4.0 to about 5.0, and most preferably to a pH of from about 4.6 to about 4.8. To effect coagulation by natural souring, milk is held in vats to ferment, causing lactic acid to form. The milk is fermented for a sufficient period of time to allow the formed lactic acid to coagulate a substantial portion of the casein in the milk. To effect coagulation of casein with rennet, sufficient rennet is added to the milk to precipitate a substantial portion of the casein in the milk. Acid coagulated, naturally soured, and rennet precipitated casein are all commercially available from numerous manufacturers or supply houses.

Corn protein materials that are useful in the present invention include corn gluten meal, and most preferably, zein. Corn gluten meal is obtained from conventional corn refining processes, and is commercially available. Corn gluten meal contains about 50% to about 60% corn protein and about 40% to about 50% starch. Zein is a commercially available purified corn protein which is produced by extracting corn gluten meal with a dilute alcohol, preferably dilute isopropyl alcohol.

Wheat protein materials that are useful in the process of the present invention include wheat gluten. Wheat gluten is obtained from conventional wheat refining processes, and is commercially available.

A particularly preferred modified soy protein material is a soy protein isolate that has been enzymatically hydrolyzed and deamidated under conditions that expose the core of the proteins to enzymatic action as described in European Patent No. 0 480 104 B1, which is incorporated herein by reference. Briefly, the modified protein isolate material disclosed in European Patent No. 0 480 104 B1 is formed by: 1) forming an aqueous slurry of a soy protein isolate; 2) adjusting the pH of the slurry to a pH of from 9.0 to 11.0; 3) adding between 0.01 and 5% of a proteolytic enzyme to the slurry (by weight of the dry protein in the slurry); 4) treating the alkaline slurry at a temperature of 10° C. to 75° C. for a time period effective to produce a modified protein material having a molecular weight distribution (Mn) between 800 and 4000 and a deamidation level of between 5% to 48% (typically between 10 minutes to 4 hours); and deactivating the proteolytic enzyme by heating the slurry above 75° C. The modified protein material disclosed in European Patent No. 0 480 104 B1 is commercially available from Solae®, LLC.

The Flavoring Material

A coagulated protein material by itself can have an undesired aftertaste or undesired flavors. The function of the flavoring material is to mask any adverse flavors of the coagulated protein material and to give a pleasant taste to the food composition. The flavoring material can be selected from the group consisting of a fruit juice, a vegetable juice, a fruit acid, citric acid, malic acid, tartaric acid, lactic acid, ascorbic acid, α-glucono delta lactone, phosphoric acid, and mixtures thereof.

As a juice, the fruit and/or vegetable may be added in whole, as a liquid, a liquid concentrate, a puree, or in another modified form. The liquid from the fruit and/or vegetable may be filtered prior to being used in the juice product. The fruit juice can include juice from tomatoes, berries, citrus fruit, melons, tropical fruits, and mixtures thereof. The vegetable juice can include a number of different vegetable juices and mixtures thereof. Examples of a few of the many specific juices which may be utilized in the present invention include juice from berries of all types, currants, apricots, peaches, nectarines, plums, cherries, apples, pears, oranges, grapefruits, lemons, limes, tangerines, mandarin, tangelo, bananas, pineapples, grapes, tomatoes, rhubarbs, prunes, figs, pomegranates, passion fruit, guava, kiwi, kumquat, mango, avocados, all types of melon, papaya, turnips, rutabagas, carrots, cabbage, cucumbers, squash, celery, radishes, bean sprouts, alfalfa sprouts, bamboo shoots, beans, seaweed, and mixtures thereof. One or more fruits, one or more vegetables, and/or one or more fruits and vegetables, can be included in the acid beverage to obtain the desired flavor of the acid beverage.

The fruit juice and/or the vegetable juice can be included in the composition in amounts equal to between about 1% to about 98% of the food composition. Prefereably in an amount equal to between about 5% to about 30% of the food composition, and more preferably in an amount equal to about 10% to about 15% of the food composition.

Fruit and vegetable flavors can also function as the flavoring material. Fruit flavoring has been found to neutralize the aftertaste of protein materials. The fruit flavoring may be natural flavoring, artificial flavoring, and mixtures thereof. The fruit flavoring is best when used with other flavoring materials such as vegetable flavoring to enhance the characterizing flavor of the acid beverage and also to mask any undesirable flavor notes that may derive from the protein material.

In one embodiment, for products having a high protein load, scrape-surface heat exchanges and meat processing equipment can be used instead of the beverage mixing equipment and liquid homogenizer. Meat processing equipment includes a ball chopper and an emulsifier.

In a further embodiment, the food composition can contain both higher amounts of protein and higher amounts of fiber than typically found in similar food compositions.

In yet another embodiment, the food composition is an acid beverage containing higher amounts of protein and higher amounts of fiber than typically found in an acid beverage, and containing fruit juice in the amount of at least about 10% of the total acid beverage. A typical serving size between about 10 ounces to about 12 ounces would include between about 8 grams to about 13 grams of protein per serving, between about 4 grams to about 6 grams of fiber per serving, and at least about 10% fruit juice per serving.

The invention having been generally described above, may be better understood by reference to the examples described below. The following examples represent specific but non-limiting embodiments of the present invention.

### EXAMPLES

An aqueous coagulant solution is prepared comprising a-glucono delta lactone and at least one magnesium salt, calcium salt, zinc salt, or mixtures thereof as earlier described and at the earlier disclosed ratio. The coagulant solution is added to the homogenized protein second slurry and the contents are mixed to effect coagulation.

### Example 1

Tap water (4182 g) is added to a vessel. Stirring is begun and 1200 g of soy protein isolate identified as FXP HO120, available from Solae® LLC is added. The contents are stirred for 3 minutes at high shear to effect hydration. Stirring is continued and the contents are heated to 70° C. and held at this temperature for 5 minutes to complete hydration. Sunflower oil (800 g) and 800 g of maltodextrin are slowly added. The contents are then homogenized at 2500 pounds per square inch in the first stage and at 500 pounds per square inch in the second stage. The contents are returned to the vessel and heated to 90° C. for 30 seconds. A coagulant solution of 3.5 g of calcium sulfate and 14 g of α-glucone delta lactone in 100 g of 60° C. tap water is prepared and added to the vessel. A coagulate is formed and the coagulate is mixed for 60 seconds. The coagulate contains 17.14% soy protein.

### Example 2

The procedure of Example 1 is repeated, except that 1200 parts Supro® Plus 651 available from Solae® LLC is utilized in place of the FXP HO120.

### Example 3

The procedure of Example 1 is repeated, except that 1200 parts Supro® XT 40 available from Solae® LLC is utilized in place of the FXP HO120.

### Example 4

Tap water (7915 g) is added to a vessel. Stirring is begun and 2057 g of soy protein isolate identified as Supro® XT 40, available from Solae® LLC is added. The contents are stirred for 3 minutes at high shear to effect hydration. Stirring is continued and the contents are heated to 70° C. and held at this temperature for 5 minutes to complete hydration. Sunflower oil (1000 g) and 1000 g of maltodextrin are slowly added. The contents are then homogenized at 2500 pounds per square inch in the first stage and at 500 pounds per square inch in the second stage. The contents are returned to the vessel and heated to 90° C. for 30 seconds. A coagulant solution of 5.8 g of calcium sulfate and 23 g of α-glucone delta lactone in 10 g of 60° C. tap water is prepared and added to the vessel. A coagulate is formed and the coagulate is mixed for 60 seconds. The coagulate contains 17.14% soy protein.

Acid beverages are prepared using the above components according to the processes of the present invention. It is understood that other components may be present within the acid beverage. These other components include, but are not limited to, vegetable protein fibers, fruit flavors, food colorants, vitamin/mineral blends, and mixtures thereof.

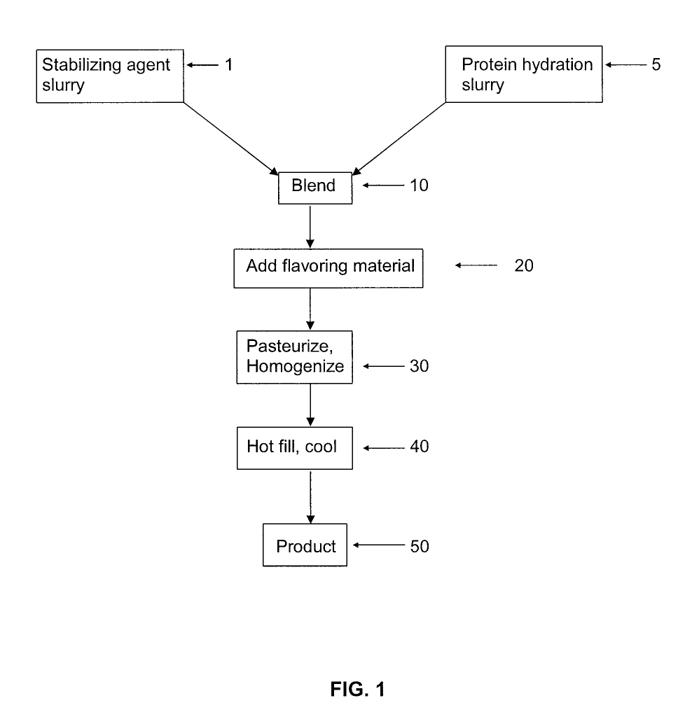

Example A is a baseline process example as defined within FIG. 1. The acid beverage composition of this example employs a non-coagulated protein as a protein source.

### Example A

A 6.5 g protein per 8 oz serving fortified juice beverage is made using Supro® XT 40 protein made by Solae® LLC.

Distilled water (5494 g) is added to a vessel followed by 332 g of Supro® XT 40 protein. The contents at 5.70% solids are dispersed under medium shear, mixed for 5 minutes, followed by heating to 77° C. (170° F) for 10 minutes to give a protein suspension slurry. In a separate vessel, 60 grams of pectin (YM-100L) are dispersed into 2940 grams of distilled water under high shear to give a 2% pectin dispersion. The dispersion is heated to 77° C. (170° F.) until no lumps are observed. The pectin dispersion is added into the protein suspension slurry and mixed for 5 minutes under medium shear. This is followed by the addition of 27 grams of citric acid, 27 grams of phosphoric acid, 210 grams of concentrated apple juice and 1000 grams of sugar. The contents are mixed for 5 minutes under medium shear. The pH of this mixture at room temperature is in the range of 3.8-4.0. The contents are pasteurized at 91° C. (195° F.) for 30 seconds, and homogenized at 2500 pounds per square inch in the first stage and 500 pounds per square inch in the second stage to give a protein stabilized acid beverage. Bottles are hot filled with the beverage at 82° C.-85° C. (180° F.-185° F.). The bottles are inverted, held for 2 minutes and then placed in ice water to bring the temperature of the contents to about room temperature. After the contents of the bottles are brought to about room temperature, the bottles are stored at room temperature for 2 months.

### Example 5

A 5.5 g protein per 8 oz serving fortified juice beverage is prepared. First, 1106 g of tap water, 34.2 g of pectin, and 68.4 g of sucrose are added to a vessel. The contents are stirred and heated to 77° C. (170° F.) in order to hydrate the pectin, followed by a cooling period. The coagulated protein (1702 g) of Example 4 that contains 17.14% protein is added to a second vessel. Tap water (7545 g) is added to the second vessel. The coagulated protein is heated to 79° C. (175° F.) and held for 5 minutes. The hydrated pectin in the first vessel, is added to the coagulated protein in the second vessel, followed by a stirring period of 5 minutes. The flavoring material of 102 g of pear juice concentrate is added followed by 981 g of sucrose, 90 g of a vitamin/mineral premix, and 65 g of citric acid to adjust the pH to 3.8. Stirring is continued and 94 g of protein fiber, 33.6 g of strawberry flavor, 6 g of banana flavor, 10 g of gum arabic, 7 g of carmine, and 0.1 g of RC&C Red #40 are added. The contents are pasteurized at 91° C. (195° F.) for 30 seconds and homogenized at 2500 pounds per square inch in the first stage and 500 pounds per square inch in the second stage. Bottles are hot filled, inverted for 2 minutes and then placed in ice water to bring the temperature of the contents to about room temperature. After the contents of the bottles are brought to about room temperature, the bottles are stored at room temperature for 2 months.

The serum and sediment values are determined by filling 250 milliliter narrow mouth square bottles (Nalge Nunc International) with each beverage. The percentage of sediment and percentage of serum of each sample is then measured to determine the effectiveness of stabilization in each beverage. Sediment is the solid material that has fallen out of solution/suspension; serum is the clear layer of solution containing little or no suspended protein. The percentage of sediment is determined by measuring the height of the sediment layer in the sample and measuring the height of the entire sample, where Percent Sediment=(Ht. Sediment layer)/(Ht. Total Sample)×100. The percentage of serum is determined by measuring the height of the serum layer in the sample and measuring the height of the entire sample, where Percent Serum=(Ht. Serum Layer)/(Ht. Total Sample)×100. Visual observations are also made with respect to the homogeneity, or lack thereof, of the samples. The results of the tests are shown in Table 1 below.

The baseline process beverage Example A and the inventive process beverage Example 5 are compared to each other, protein for protein, in Table I.

TABLE I
One Month Acid Beverage Evaluations

| | Example A | Example 5 |
|---|---|---|
| pH | 4.02 | 3.79 |
| Viscosity at 25° C. ¹ | 6.0 Cps | 23.5 Cps |
| % Serum | 0 | 0 |
| % Sediment | 3.3 | 0 |
| Observation | not stable | stable |

¹ Brookfield Model DV-II viscometer equipped with spindle S18. The examples are run at 60 rpm. The reported values are in centipoise (Cps).

It is observed from the storage sediment data of the above examples that the composition encompassing the process of the present invention offers an improvement in less sediment, in preparing a protein based acid beverage over the normal process for preparing the beverage.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A food composition, comprising;
(A) a protein stabilizing agent;
(B) a dispersed coagulated protein material; and
(C) a flavoring material.

2. The composition of claim 1 wherein the dispersed coagulated protein material is prepared by a process comprising
(1) hydrating a protein material to form a first aqueous slurry mixture;
(2) adding at least one supporting material to the first aqueous slurry mixture to form a second aqueous slurry mixture;
(3) homogenizing the second aqueous slurry mixture to a homogenate; and
(4) adding a coagulant having a pH of from about 3.8 to about 7.2 to the homogenate to form a dispersed coagulated protein.

3. An acid beverage composition, comprising;
(A) a hydrated protein stabilizing agent;
(B) a dispersed coagulated protein material; and
(C) a flavoring material is selected from the group consisting of a fruit juice, a vegetable juice, citric acid, malic acid, tartaric acid, lactic acid, acetic acid, ascorbic acid, and mixtures thereof;
wherein the acid beverage has a pH of between about 3.0 to about 4.5.

4. The process of claim 3 wherein the hydrated protein stabilizing agent comprises a hydrocolloid.

5. The composition of claim 4 wherein the hydrocolloid is selected from the group consisting of alginate, microcrystalline cellulose, jellan gum, tara gum, carrageenan, guar gum, locust bean gum, xanthan gum, cellulose gum, pectin, and mixtures thereof.

6. The composition of claim 3 wherein the hydrated protein stabilizing agent is a high methoxyl pectin.

7. The composition of claim 3 wherein the hydrated protein stabilizing agent is present at from about 0.5% to about 5% by weight of the total composition.

8. The composition of claim 3 wherein the pH of the protein stabilizing agent is from about 2.0 to about 5.5.

9. The composition of claim 3 wherein the dispersed coagulated protein material is prepared by a process comprising
(1) hydrating a protein material to form a first aqueous slurry mixture;
(2) adding at least one supporting material to the first aqueous slurry mixture to form a second aqueous slurry mixture;
(3) homogenizing the second aqueous slurry mixture to a homogenate; and
(4) adding a coagulant having a pH of from about 3.8 to about 7.2 to the homogenate to form a dispersed coagulated protein.

10. The composition of claim 9 wherein the protein material is a vegetable protein material selected from the group consisting of legume protein materials, soy protein materials, pea protein materials, rapeseed protein materials, canola protein materials cottonseed protein materials, corn protein materials, wheat gluten, vegetable whey proteins, and mixtures thereof.

11. The composition of claim 10 wherein the vegetable protein material is a soy protein material.

12. The composition of claim 11 wherein the soy protein material is selected from the group consisting of soy protein flour, soy protein concentrate, soy protein isolate, and mixtures thereof.

13. A process for preparing a stable suspension of a protein material in an acid beverage, comprising;
combining
(A) a hydrated protein stabilizing agent;
(B) a dispersed coagulated protein material; and
(C) a flavoring material selected from the group consisting of a fruit juice, a vegetable juice, citric acid, malic acid, tartaric acid, lactic acid, acetic acid, ascorbic acid, and mixtures thereof; to form a blend and
pasteurizing and homogenizing the blend;
wherein the acid beverage has a pH of between about 3.0 to about 4.5.

14. The process of claim 13 wherein the dispersed coagulated protein material is prepared by a process comprising
(1) hydrating a protein material to form a first aqueous slurry mixture;
(2) adding at least one supporting material to the first aqueous slurry mixture to form a second aqueous slurry mixture;
(3) homogenizing the second aqueous slurry mixture to a homogenate; and
(4) adding a coagulant having a pH of from about 3.8 to about 7.2 to the homogenate to form a dispersed coagulated protein.

15. The process of claim 13 wherein the weight ratio of the hydrated protein stabilizing agent: the dispersed coagulated protein: the flavoring material is about 5-15:15-25:60-75.
